(19) United States
(12) Patent Application Publication
(10) Pub. No.: US 2005/0015311 A1
(43) Pub. Date: Jan. 20, 2005

(54) System and method for aggregate online ordering using barcode scanners

(76) Inventors: Didier Frantz, New York, NY (US); Punit Raizada, Newark, NJ (US)

Correspondence Address: Scanbuy, Inc.;Fourth Floor, 54 West 39th Street, New York City, NY, 10018, US

(21) Appl. No.: 10/823,757

(22) Filed: Apr. 14, 2004

Related U.S. Application Data
(60) Provisional application No. 60/487,276, filed on Jul. 16, 2003.

(51) Int. Cl. G06F 17/60

(52) U.S. Cl. 705/26

(57) ABSTRACT

The present invention discloses a system and method for placing orders utilizing barcode scanning technology. A user of the system utilizes a barcode scanner to scan the barcodes for all the objects the user wishes to order. The user then uploads this information to a computer. A software application located on the computer parses the information and assigns each scanned product to a vendor based upon the user's predetermined preferences. The application then launches a browser with a populated shopping cart at each vendor's e-commerce website. The user can then utilize the different e-commerce websites to complete the ordering transaction.

### PARENT CASE TEXT

This application claims the benefit of provisional application No. 60/487,276 filed Jul. 16, 2003.

### FIELD OF THE INVENTION

The present invention relates to the field of online shopping using barcode scanners. More specifically, the present invention provides an improved system and method for ordering from multiple vendors using a single barcode scanner and software application.

### BACKGROUND

Integrating barcode scanning technology into existing e-commerce websites is painfully long and complex. It requires an extensive integration process and many changes to the e-commerce application-provider. Any user wishing to utilize the barcode scanner services and products would need to first register with the providing company and obtain the required software and hardware. Once they have the software, the user must go through an extensive and sometimes very complicated setup process. Many changes are necessary in tight network configurations in order to allow users to install software on their machines. Also, the software consumes system resources and requires a constant internet connection. These are all factors that contribute to degrade performance of a user's machine unnecessarily.

Existing e-commerce websites desiring to upgrade their websites would need to undergo changes and modifications on their end to handle data being passed to them from this software. The e-commerce website needs to add complex processes in order to handle and parse this data in addition to their current processes. For large e-commerce websites, this can mean causing parts (or even the whole) of their site to be rendered unoperational if not carefully planned and implemented.

The process of ordering using barcode scanners takes the users away from their primary dealer's site. Since this process would generally be handled by a stand-alone software application, there is no relation between the two distinct methods (traditional online ordering and ordering using barcodes). It is very difficult to monitor the environment in which the user is working and entering their order. Since the user's atmosphere is different, there is no correlation in the user's mind regarding this service and the dealer's service; the two methods of ordering appear to be completely separate.

In addition, any changes made to the existing e-commerce platform affects the software application, thus making the software unoperational and useless. This places a very strict limitation as far as services the e-commerce platform can make available to their customers, thereby prohibiting growth.

Additionally, most stand-alone software applications designed to integrate barcode scanning technology into e-commerce websites are designed to interface only with a single vendor. Therefore, if a user desires to use barcode scanning technology to order from multiple vendors, the user must install a software application from each vendor. Also, the barcode scanners provided by each vendor may not be the same; thereby requiring the user to remember which barcode scanner must be used with which application.

Therefore, there clearly exists a need for a system and method which enables users to place orders from multiple vendors using a single software application and barcode scanner. Such a system would allow users to order from multiple vendors utilizing a single software application.

### SUMMARY OF THE INVENTION

The present invention provides a system and method which allows users to place orders at multiple websites using a single software application and barcode scanner. The system of the present invention is designed to facilitate quick online ordering using barcode scanning technology in unison with a user-friendly software application.

Prior to using the system of the present invention, the user must install the required software on his/her computer and acquire a barcode scanner. For some vendors, the user must input a username and password into the program so that the software program can later connect to that particular vendor's website.

The barcode scanner may be any type of barcode scanner which is currently available. The most common type of barcode scanners are laser-based scanners. These scanners have the advantage that they can scan data very quickly. However, these types of scanners are usually only able to decode a few types of barcode formats.

Optical barcode scanners, such as are disclosed in co-pending U.S. Provisional Application No. 60/487,237 entitled “ScanZoom,” have the advantage that their decoding is controlled by software. Thus, optical barcode scanners can be programmed to decode almost any type of barcode and can be updated to decode newer barcode formats.

Additionally, if a mobile device is utilized as a barcode scanner, the scanned barcode information can later be transmitted to the processing application wirelessly, thereby eliminating the need to connect the barcode scanner directly to the computer.

To utilize the system of the present invention, a user first scans the barcodes of the products which the user desires to order. The user can either scan the barcodes located on most products or the user can scan the barcodes from a specially created catalogue which contains a barcode next to each displayed item.

To order multiple quantities of a single item, the user can scan the barcode multiple times or the user can first scan the product barcode and then a “quantity” barcode. For example, to order fifteen quantities of a particular product, the user would first scan the barcode related to the product, scan a quantity barcode indicating a quantity of ten, and then scan a quantity barcode indicating a quantity of five.

Once the user has scanned all the desired products for ordering, the user connects the barcode scanner to the computer and launches the software application of the present invention. Depending upon the specific type of scanner and/or software application, the barcode information may be automatically acquired by the software program or the user may have to initiate a manual upload. The software application then creates shopping lists according to the user's preferred vendors.

In each shopping list, the software program scans the barcode information for instances of quantity barcodes. When quantity barcodes are found, the software application replaces the quantity barcode with X-1 copies of the product barcode, where X refers to the quantity of the quantity barcode.

Once these shopping lists have been created, the software application launches the e-commerce website of each vendor and sends the product information to each vendor via XML (XML is the standard by which most e-commerce websites communicate such types of information). This causes the products to appear in the shopping cart of each vendor along with the correct quantities. The user may then review the shopping cart of each vendor and click “order” or “purchase” once the user has verified each order is correct.

The present invention can also be adapted to work with Radio Frequency Identification (“RFID”) labeling systems. In this scenario, the barcode scanner would simply be replaced with a RFID scanner. The only other change to the system that would have to occur is that the barcode information contained in the product databases would have to be replaced with the corresponding RFID tag information. A similar process can be utilized to allow the system of the present invention to function with any tagging or labeling system available or which may become available.

Therefore, it is an object of the present invention to provide an ordering system capable of aggregating orders for multiple vendors using a single software application and barcode scanner.

It is an additional object of the present invention to provide an ordering system which is rapid and user-friendly.

Another object of the present invention is to provide an ordering system capable of utilizing both standard and proprietary barcode formats.

It is yet another object of the present invention to provide an ordering system which requires minimum modification of the vendors' existing e-commerce website.

An additional object of the present invention is to provide an ordering system which uses vendor preferences to automatically sort products and place orders.

These and other objects of the present will be made clearer with reference to the following detailed description and accompanying drawings.

### BRIEF DESCRIPTION OF THE DRAWINGS

FIG. 1 depicts the system architecture for use with the preferred embodiment of the invention.

FIG. 2 depicts a flowchart showing the steps utilized for scanning and order processing in the preferred embodiment of the invention.

FIG. 3 depicts an expanded flowchart of the uploading step shown in FIG. 2.

FIG. 4 depicts an expanded flowchart of the barcode information parsing step shown in FIG. 2.

### DETAILED DESCRIPTION OF THE PREFERRED EMBODIMENT(S)

The following presents a detailed description of a preferred embodiment (as well as some alternative embodiments) of the present invention. However, it should be apparent to one skilled in the art that the described embodiment may be modified in form and content to be optimized for a wide variety of situations.

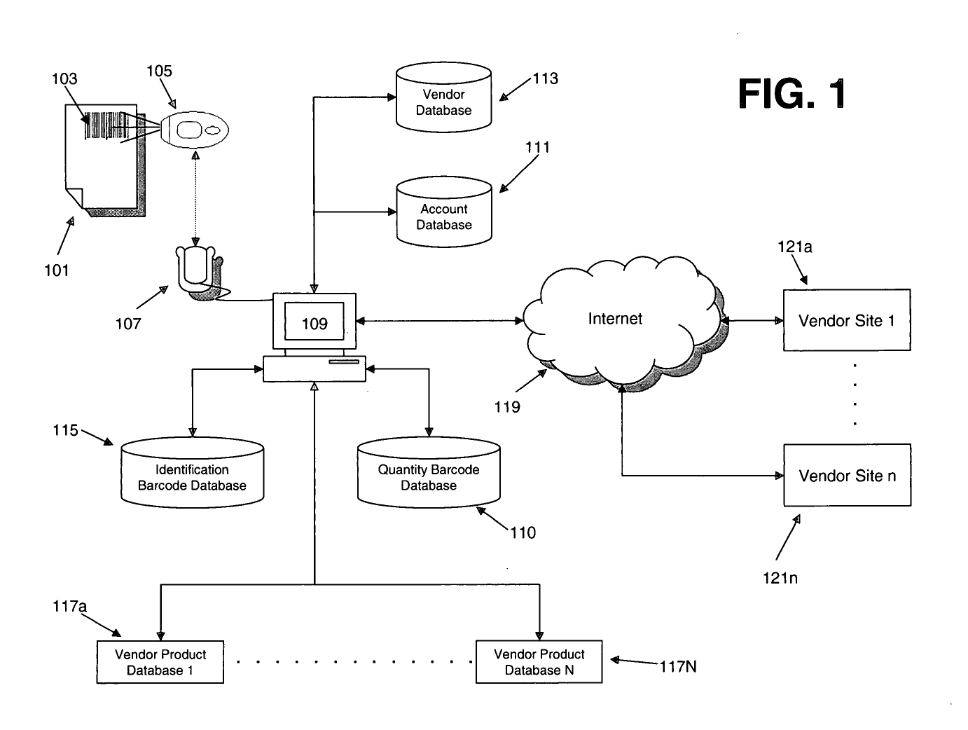

Referring first to FIG. 1, shown is a system diagram depicting the hardware configuration for use with the preferred embodiment of the present invention. In this figure, data carrier 101 is shown containing barcode 103. Barcode 103 may either be a one or two-dimensional barcode. However, it should be apparent to one skilled in the art that barcode 103 may be any machine readable code. A user utilizes scanner 105 to scan barcode 103. Scanner 105 converts the barcode information into a string of characters which is recognizable by a computer.

Scanner 105 may be any type of scanner capable of scanning barcodes. The most widely used type of barcode scanners are laser-based scanners which are adapted to scan one-dimensional barcodes. Barcode scanners designed to scan two-dimensional barcodes are also currently available but are more expensive than their one-dimensional counterparts.

Scanner 105 may also utilize scanners which use “optical intelligence” which is described in co-pending Provisional U.S. Application No. 60/487,237 entitled “ScanZoom.” Optical intelligence allows any device (mobile or stationary) equipped with a digital camera to function as a barcode scanner.

Cradle 107 is used to connect scanner 105 to computer 109. Alternatively, scanner 105 may connect directly to computer 109 via a direct cable connection using one of computer 109's available ports (serial, USB, etc.). Scanner 105 may also utilize a wireless connection to connect to computer 109. For example, in the case where scanner 105 is a mobile device utilizing optical intelligence, such as a camera phone, all of the barcode information can be transmitted to computer 109 wirelessly utilizing a wireless connection (Bluetooth, WiFi, cellular network, etc.). Computer 109 contains the software which reads the information from barcode scanner 105 and correctly processes it.

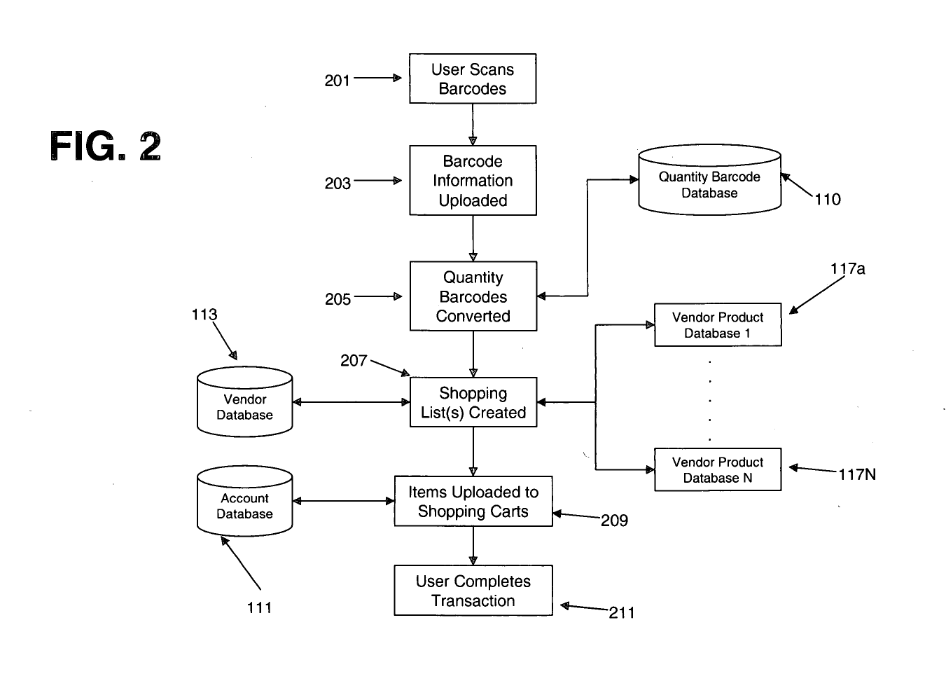

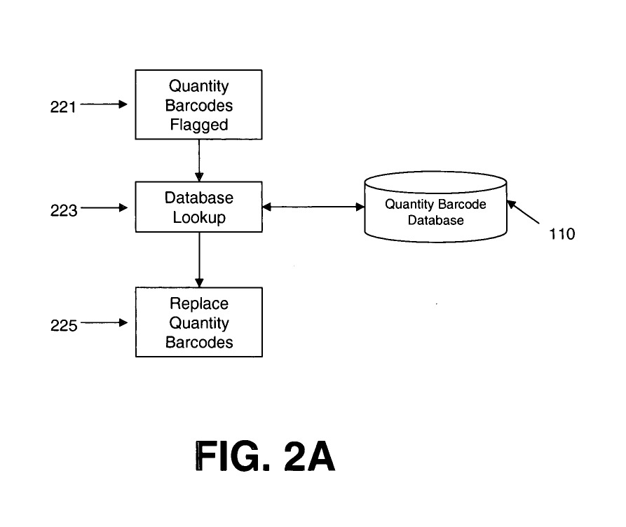

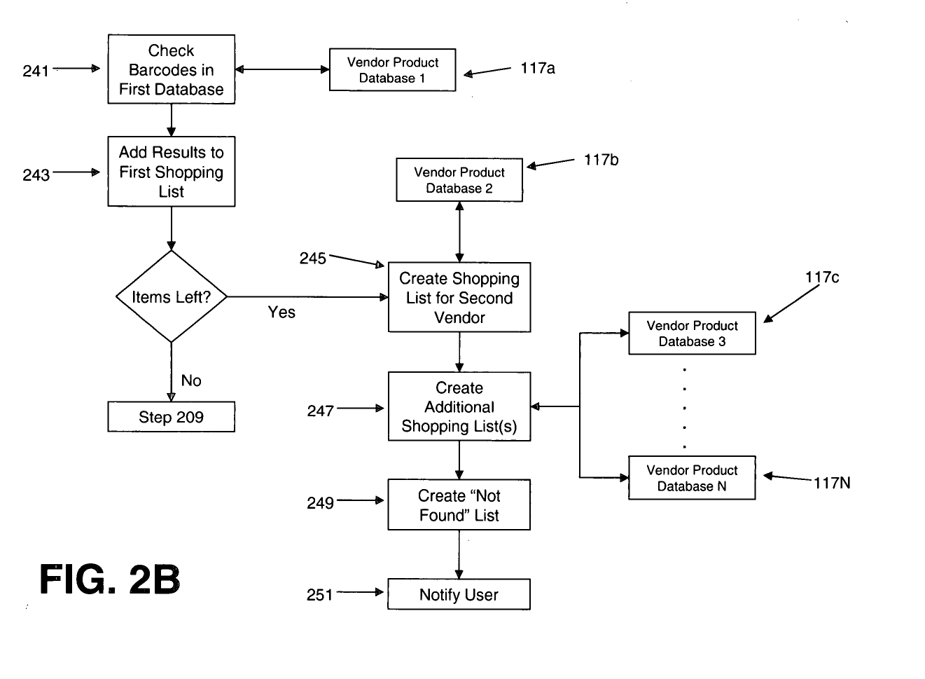

To function properly, the barcode processing software located on computer 109 requires the use of one or more databases. As shown in FIG. 1, computer 109 contains quantity barcode database 110, individual account database 111, vendor database 113, identification barcode database 115, and vendor product database 117. Quantity database 110 is a lookup table which indicates the sum to which each quantity barcode corresponds. Account database 111 stores the login information of the user required to access each of the selected vendor's website. Vendor database 113 is a database which stores the information required to access each vendor's website. Individual barcode database 115 contains information required by the software to decode the quantity scanned from quantity barcodes. Vendor product databases 117a-117n contain a list of the products and associated barcode numbers for each product of each vendor. The function and purpose of each database in the processing of the information acquired via scanner 105 will be described in FIG. 2.

Internet 119 is used to connect computer 109 to vendor websites 121a-121n which allow for the aggregate ordering. The internet connection may either be permanent, such as a DSL or cable connection, or provided through a modem.

Now referring to FIG. 2, shown is a flowchart depicting the steps utilized for aggregate ordering in the preferred embodiment of the present invention. In the preferred embodiment, a user first scans all of the products the user wishes to order in step 201 using barcode scanner 105. To accomplish this, the user can either scan the standard barcodes which are located on most products or the user can utilize special catalogues provided by different vendors which contain the printed barcode of each item next to each product. If more than one quantity of a certain product is desired, a user may utilize quantity barcodes to indicate the desired quantity of items. Quantity barcodes are utilized by first scanning the barcode of the product and then scanning the quantity barcode(s).

Once all of the products have been scanned in step 201, the user uploads the scanned barcode information to computer 109 in step 203 utilizing cradle 107. Alternatively, scanner 105 could be connected directly to computer 109 through a wired or wireless connection. The software located on computer 109 facilitates the uploading of the barcode information by synching scanner 105 with computer 109. The barcode information is uploaded to the computer as a character string, wherein different portions of the character string correspond to the different barcodes scanned.

If RFID tags are utilized instead of barcodes, scanner 105 would be a RFID scanner. The process of uploading the information to computer 109 would occur in a similar manner to uploading barcode information.

After the barcode information has been uploaded to computer 109, the software next processes the quantity barcodes in step 205. As shown in FIG. 2A, the software first searches the uploaded barcode information for all instances of quantity barcodes in step 221 and flags the results. The software next uses quantity barcode database 110 to associate each quantity barcode with a particular sum in step 223. The software then systematically replaces each quantity barcode with the number of copies of the product barcode which immediately precedes it in step 225. For example, if the software found a barcode for a heavy-duty stapler followed by a quantity barcode indicating a quantity of five, the software would replace the quantity barcode with four additional copies of the barcode for the heavy-duty stapler.

Referring back to FIG. 2, the software next assigns each barcode to a particular vendor based upon the user's predetermined vendor preferences in step 207. The order of preference for the vendors is stored in vendor database 113. The software accomplishes this by processing each barcode individually. As shown in FIG. 2B, each of the barcodes is first checked to see if it is located in the first preferred vendor product database 117a in step 241. All of the barcodes found located in database 117a are added to a shopping cart list which corresponds to the first preferred vendor in step 243. If all of the barcodes are found in the first preferred vendor database 117a, the software proceeds to step 209. However, if some barcodes are not found, the software next searches second preferred vendor database 117b and creates a second shopping cart list which corresponds to the second preferred vendor in step 245. This process is repeated using the list of preferred vendors until each of the uploaded barcodes has been added to a shopping cart list corresponding to one of the preferred vendors in step 247. The products which could not be found in any database are stored in a separate list in step 249. The software then displays a message to the user which indicates which products could not be located in step 251.

To allow the system of the present invention to function with a RFID tagging system, the barcode information in vendor databases 117a-117n simply has to be replaced with the corresponding RFID information.

Next, referring back to FIG. 2, the software sends each of the created shopping cart lists to each of the vendors' e-commerce websites 121a-121n using XML via Internet 119 in step 109. Currently, XML is the standard method of transmitting such information. However, it should be apparent to one skilled in the art that additional methods of transmitting such information will become available and can be utilized with the present invention. If login or account information is required by some vendors, the software utilizes vendor account database 111 to transmit the login information along with the shopping cart list. A web browser is opened for each the e-commerce websites utilized. The shopping cart of each website is displayed populated with the uploaded items and corresponding quantities.

The user may then complete the ordering in step 211 by confirming that each shopping cart has the correct items and quantities. Typically, the e-commerce websites can be used to add/remove items and/or change quantities if the user desires. Once the user is satisfied with each shopping cart list, the user may execute the order on each e-commerce website.

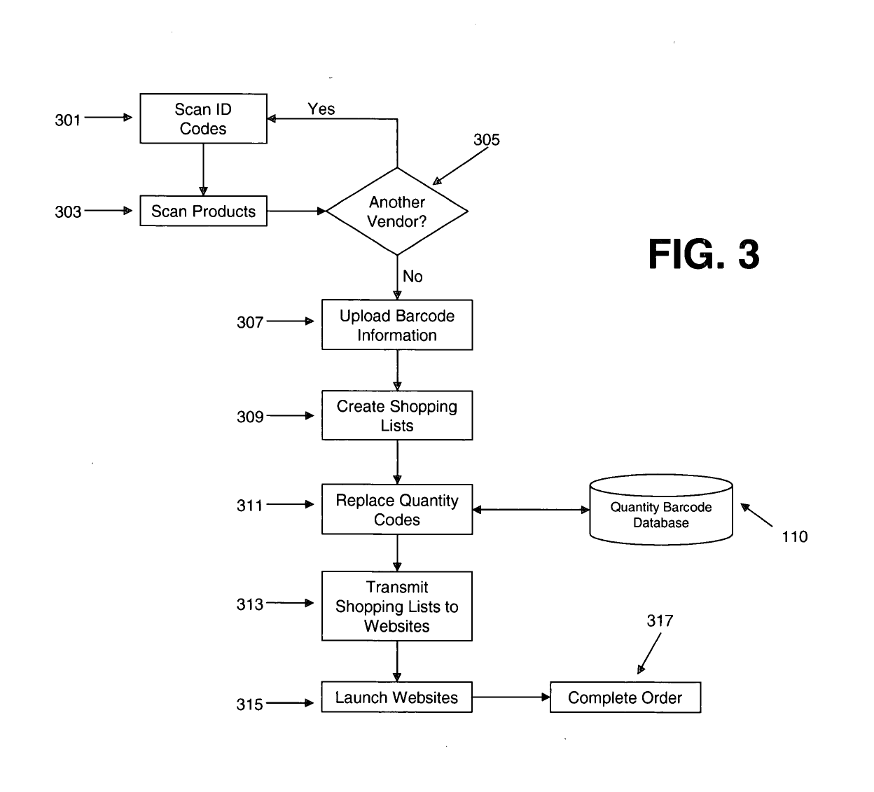

Referring next to FIG. 3, shown is an alternate embodiment of the present invention in which identification barcodes are utilized. To utilize this embodiment requires that the user first must obtain catalogues from all of the vendors from which the user desires to order products. In each catalogue, a barcode is provided next to the display or description of each item. The barcode can either be a proprietary barcode assigned to each item by the vendor or it may be the standard barcode which is assigned to each product (e.g., UPC, ISBN, etc.).

The user must also install the software of the present invention on his/her computer and acquire a barcode scanner. For some vendors, the user must input a username and password into the program so that the software program can later connect to that particular vendor's website. This information is stored in vendor account database 111.

Once the user has acquired the correct catalogues and barcode scanner and installed the software, the user is ready to utilize the system of the present invention. First, utilizing scanner 105, the user scans the identification barcode which has been assigned to each vendor of the system in step 301. The identification barcode may be printed directly on the catalogue or on any data carrier capable of being scanned by a barcode scanner. Next, the user scans all the products from the vendor's catalogue which the user desires to order in step 303. To order multiple quantities of a single item, the user can scan the barcode multiple times or the user can first scan the product barcode and then a quantity barcode. For example, to order fifteen quantities of a particular product, the user would first scan the barcode related to the product, scan a quantity barcode indicating a quantity of ten, and then scan a quantity barcode indicating a quantity of five.

A user may also order items from a particular vendor by scanning the standard barcodes (e.g., UPN, ISBN, etc.) located on most products. For example, if a user could not find the entry for a particular soft drink in the vendor's catalogue, the user could scan the UPC barcode directly off of the soft drink itself.

After the user has scanned all of the desired products for the first vendor, the user next scans the identification barcode of the next vendor in step 305. The user may then scan all of the products which the user desires to order from the second vendor. This process is repeated for each vendor through which the user desires to place an order.

Once the user has scanned all the desired products for ordering, the user connects scanner 105 to computer 109 and launches a software application to upload the barcode information in step 307. Depending upon the specific type of scanner and/or software application, the barcode information may be automatically acquired by the software program or the user may have to initiate a manual upload. The software application then separates the barcode information according to each vendor and creates a shopping list for each vendor in step 309. The identification barcode is used to indicate which products should be added to which shopping list.

Next, in step 311, the software program replaces the quantity barcodes in each shopping list utilizing the procedure already described in FIG. 2A. The software application then sends each shopping list to each vendor's e-commerce website in step 313 via XML (XML is the standard by which most e-commerce websites communicate such types of information). A web browser is then launched on computer 109 showing each shopping cart fully populated with the scanned items in step 315. The user may then review the shopping cart of each vendor and click “order” or “purchase” once the user has verified each order is correct in step 317. This process is advantageous because it does not require the utilization of a multitude of vendor product databases 117 which may take a great deal of memory to store depending upon the size of each database.

While the foregoing embodiments of the invention have been set forth in considerable detail for the purposes of making a complete disclosure, it should be evident to one skilled in the art that multiple changes may be made to the aforementioned description without departing from the spirit of the invention.

1. A method of aggregate ordering comprising the steps of:
scanning at least one machine readable code with a scanner;
transmitting said scanned machine readable code to a computer;
creating a shopping list for each vendor by assigning each of said machine readable codes to a vendor based upon a predetermined preference stored in said computer;
transmitting said shopping lists to the appropriate e-commerce website operated by said vendor; and
completing the aggregate ordering by placing the order using each of said e-commerce websites.

2. A method of aggregate ordering according to claim 1, wherein said machine readable code is a barcode.

3. A method of aggregate ordering according to claim 1, wherein said machine readable code is a RFID tag.

4. A method of aggregate ordering according to claim 2, wherein said barcode is constructed from at least one of the standardized barcode symbology libraries consisting of the group of UPC-A, UC-E, ISBN, RSS-14, RSS-14E, RSS-14L, Interleaved 2 of 5, EAN/JAN-8, EAN/JAN-13, Code 3, Code 39 Full ASCII, Code 128, PDF417, QR Code, or Data Matrix.

5. A method of aggregate ordering according to claim 1, wherein said step of creating shopping lists comprises the steps of:
searching a first preferred vendor database for the first scanned machine readable code;
adding said machine readable code to a first shopping list if said machine readable code is found in said first database;
adding all other machine readable codes found in said first preferred vendor database to said first shopping list; and
creating additional shopping lists using additional preferred vendor databases until each machine readable code has been added to a shopping list.

6. A method of aggregate ordering according to claim 1, wherein said scanner is a laser-based barcode scanner.

7. A method of aggregate ordering according to claim 1, wherein said scanner utilizes optical recognition techniques.

8. A method of aggregate ordering according to claim 1, wherein said scanner is a RFID scanner.

9. A system for aggregate ordering comprising:
at least one machine readable code;
a scanner capable of scanning said machine readable code;
a computer for connecting to said scanner to upload said scanned machine readable codes;
a software application located on said computer which creates a shopping list for each vendor by assigning each of said machine readable codes to a vendor based upon a predetermined preference stored in said computer, transmits said shopping lists to the appropriate e-commerce website operated by said vendor, and completes the aggregate ordering by placing the order using each of said e-commerce websites.

10. A system for aggregate ordering according to claim 9, wherein said machine readable code is a barcode.

11. A system for aggregate ordering according to claim 9, wherein said machine readable code is a RFID tag.

12. A system for aggregate ordering according to claim 10, wherein said barcode is constructed from at least one of the standardized barcode symbology libraries consisting of the group of UPC-A, UC-E, ISBN, RSS-14, RSS-14E, RSS-14L, Interleaved 2 of 5, EAN/JAN-8, EAN/JAN-13, Code 3, Code 39 Full ASCII, Code 128, PDF417, QR Code, or Data Matrix.

13. A system for aggregate ordering according to claim 9, wherein said scanner is a laser-based barcode scanner.

14. A system for aggregate ordering according to claim 9, wherein said scanner utilizes optical recognition techniques.

15. A system for aggregate ordering according to claim 9, wherein said scanner is a RFID scanner.
